(19) United States
(12) Patent Application Publication
(10) Pub. No.: US 2015/0104687 A1
(43) Pub. Date: Apr. 16, 2015

(54) BATTERY WARMING-UP SYSTEM

(71) Applicant: DENSO CORPORATION, Kariya-city (JP)

(72) Inventors: Youhei MORIMOTO, Nagoya-city (JP); Noriaki IKEMOTO, Kariya-city (JP); Tsuyoshi OKAMOTO, Kariya-city (JP); Yuutarou ITOU, Kariya-city (JP)

(21) Appl. No.: 14/513,417

(22) Filed: Oct. 14, 2014

(30) Foreign Application Priority Data
Oct. 15, 2013 (JP) 2013-214449

(51) Int. Cl. H01M 10/625; H01M 10/63; H01M 10/615

(52) U.S. Cl. CPC H01M 10/5016; H01M 10/5006; H01M 10/502; H01M 2220/20
USPC 429/120

(57) ABSTRACT

A battery warming-up system includes a main battery, an electric heating portion, and a control device. The main battery is mounted to a vehicle to supply an electric power to drive the vehicle, and is warmed by a heat generation of an inner resistance of the main battery according to an input and output of the electric power. The electric heating portion heats a compartment of the vehicle by using the electric power supplied from the main battery. The control device controls a temperature of the main battery by controlling a power supply from the main battery to the electric heating portion. The output of the main battery is increased by increasing the power supply from the main battery to the electric heating portion, and the main battery can be suitably warmed. Therefore, since a power loss due to a decrease of the inner resistance of the main battery is improved or the battery output becomes sufficient, the driving power of the vehicle can be properly ensured.

### CROSS REFERENCE TO RELATED APPLICATION

This application is based on Japanese Patent Application No. 2013-214449 filed on Oct. 15, 2013, the disclosure of which is incorporated herein by reference.

### TECHNICAL FIELD

The present disclosure relates to a battery warming-up system which warms up a main battery mounted to a vehicle.

### BACKGROUND

A main battery mounted to a hybrid vehicle or an electric vehicle supplies an electric power to drive the vehicle. When a temperature of the main battery is low and an output of the main battery is insufficient, it is possible that a driving force of the vehicle is low.

Conventionally, a technology that the main battery is warmed is well known to solve the above matters. Japanese Patent No. 3687270 discloses that an operation period of an engine is reduced to increase an output of a battery and the battery is warmed by a heat generation of an interior of the battery, in a case where a temperature of the battery is less than or equal to a predetermined temperature.

According to Japanese Patent No. 3687270, when then engine cannot be stopped or an operation of the engine cannot be restricted, for example, when the engine is being warmed or the battery is being charged, an input and output of the battery cannot be increased, and the battery cannot be warmed. When the temperature of the battery becomes lower, an inner resistance of the battery becomes greater, and a power loss becomes greater. Therefore, the output of the battery becomes insufficient, and the driving force of the vehicle may be lowered. Further, when a regeneration limit is established in a case where the temperature of the battery is low, a regeneration power is decreased.

### SUMMARY

The present disclosure is made in view of the above matters, and it is an object of the present disclosure to provide a battery warming-up system which suitably warms up a main battery without respect to a condition whether an operation of an engine can be restricted.

According to an aspect of the present disclosure, the battery warming-up system includes a main battery, an electric heating portion, and a control device. The main battery is mounted to a vehicle to supply an electric power to drive the vehicle, and is warmed by a heat generation of an inner resistance of the main battery according to an input and output of the electric power. The electric heating portion heats a compartment of the vehicle by using the electric power supplied from the main battery. The control device controls a temperature of the main battery by controlling a power supply from the main battery to the electric heating portion.

The electric heating portion includes one of a heat pump system, an electric heater, and a seat heater.

The output of the main battery is increased by increasing the power supply from the main battery to the electric heating portion, and the main battery can be suitably warmed. Therefore, since a power loss due to a decrease of the inner resistance of the main battery is improved or the battery output becomes sufficient, the driving power of the vehicle can be properly ensured.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a vehicle control system to which a battery warming-up system is applied, according to embodiments of the present disclosure;

FIG. 2 is a diagram showing the battery warming-up system according to a first embodiment of the present disclosure;

FIG. 3 is a diagram showing a vehicle air-conditioner to which the battery warming-up system is applied, according to the first embodiment;

FIG. 4 is a flowchart showing a first battery output-increasing control of the battery warming-up system according to the first embodiment;

FIG. 5A is a graph showing a relationship between a battery temperature and a heating output-increasing quantity;

FIG. 5B is a graph showing a relationship between a compartment temperature and a heating output-increasing quantity;

FIG. 5C is a graph showing a relationship between a power residual and a heating output-increasing quantity;

FIGS. 6A, 6B, 6C, and 6D are time charts showing effects of the first embodiment;

FIG. 7 is a block diagram showing the battery warming-up system according to a second embodiment of the present disclosure; and

FIG. 8 is a flowchart showing a second battery output-increasing control of the battery warming-up system according to the second embodiment.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, referring to drawings, a battery warming-up system according to the present disclosure will be described.

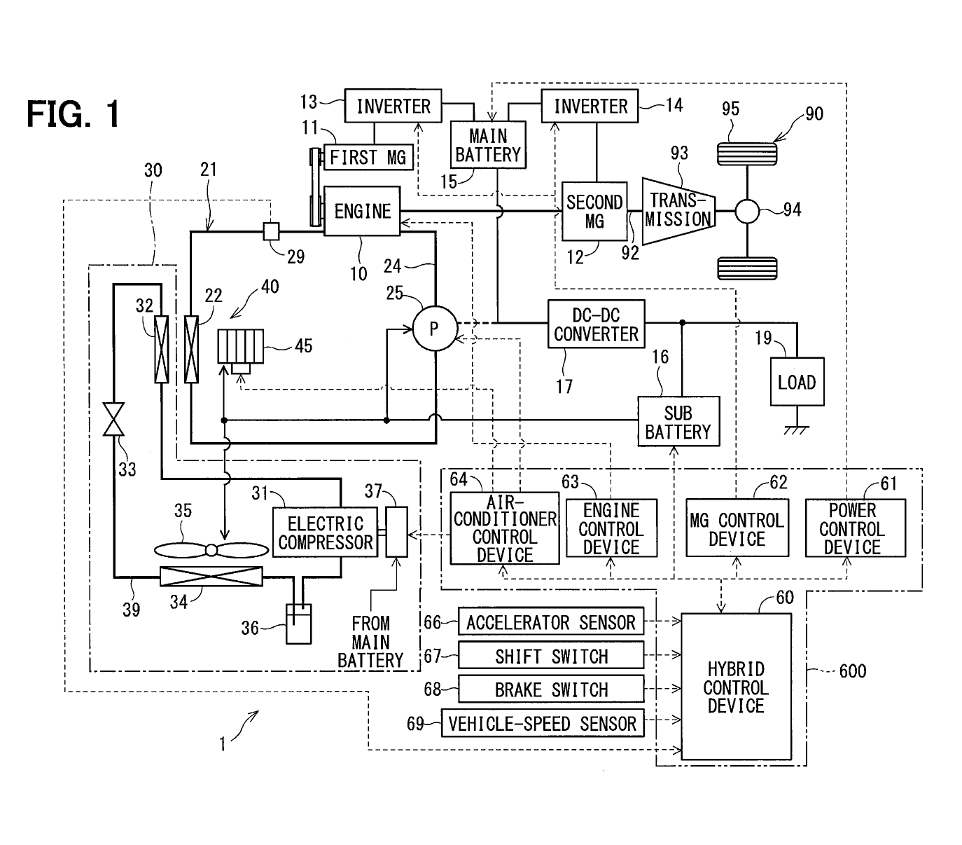

FIG. 1 is a block diagram showing a vehicle control system 1 to which a battery warming-up system is applied, according to embodiments of the present disclosure. The vehicle control system 1 includes an engine 10, a first motor generator 11, a second motor generator 12, a main battery 15, a sub battery 16, various accessories, a heat pump system 30, and a control device 600. According to the present disclosure, the motor generator is referred to as a MG.

As shown in FIG. 1, a vehicle 90 is a hybrid vehicle provided with the engine 10, the first MG 11, and the second MG 12 as driving sources. The main battery 15 is mounted to the vehicle 90 and supplies an electric power to drive the vehicle 90.

Both the first MG 11 and the second MG 12 are three-phase AC motors corresponding to permanent-magnet synchronous motors, and have an electric motor function that the first MG 11 and the second MG 12 operate using an electric power of the main battery 15 to generate a torque, and a power generator function that the first MG 11 and the second MG 12 are driven by the engine 10 or by the vehicle 90 that is braked to generate the electric power.

The first MG 11 is driven by a power of the engine 10, and is mainly used to generate the electric power. The electric power generated by the first MG 11 is supplied to the main battery 15 via an inverter 13.

The second MG 12 is power supplied from the main battery 15 via an inverter 14. The second MG 12 is mainly used as the electric motor. When the vehicle 90 is decelerated, the second MG 12 generates electric power according to a regeneration operation. The electric power generated by the second MG 12 is charged to the main battery 15 via the inverter 14.

The driving force of the engine 10 and the driving force of the second MG 12 are transmitted to a driving wheel 95 via a driving shaft 92, a transmission 93, and a differential gear 94, to rotate the driving wheel 95.

The main battery 15 includes a rechargeable battery made of nickel hydride or lithium ion. Alternatively, the main battery 15 is a power storage device corresponding to an electric double layer capacitor, and can be charged and discharged. A state of charge (SOC) of the main battery 15 corresponding to a power residual of the main battery 15 is controlled to be in a predetermined range.

A DC power of the main battery 15 is converted into an AC power by the inverters 13 and 14, and is received from or transmitted to the first MG 11 and the second MG 12.

The sub battery 16 supplies the electric power to various accessories other than directly driving the vehicle 90. The sub battery 16 is connected to the main battery 15 via a DC-DC converter 17, and is chargeable according to an electric power stepped down by the DC-DC converter 17 from the electric power of the main battery 15.

The electric power of the sub battery 16 is supplied to devices which are driven by a low voltage, such as a water pump 25, a radiator fan 35, a blower 45, or a load 19. In this case, the water pump 25, the radiator fan 35, and the blower 45 are included in the accessories.

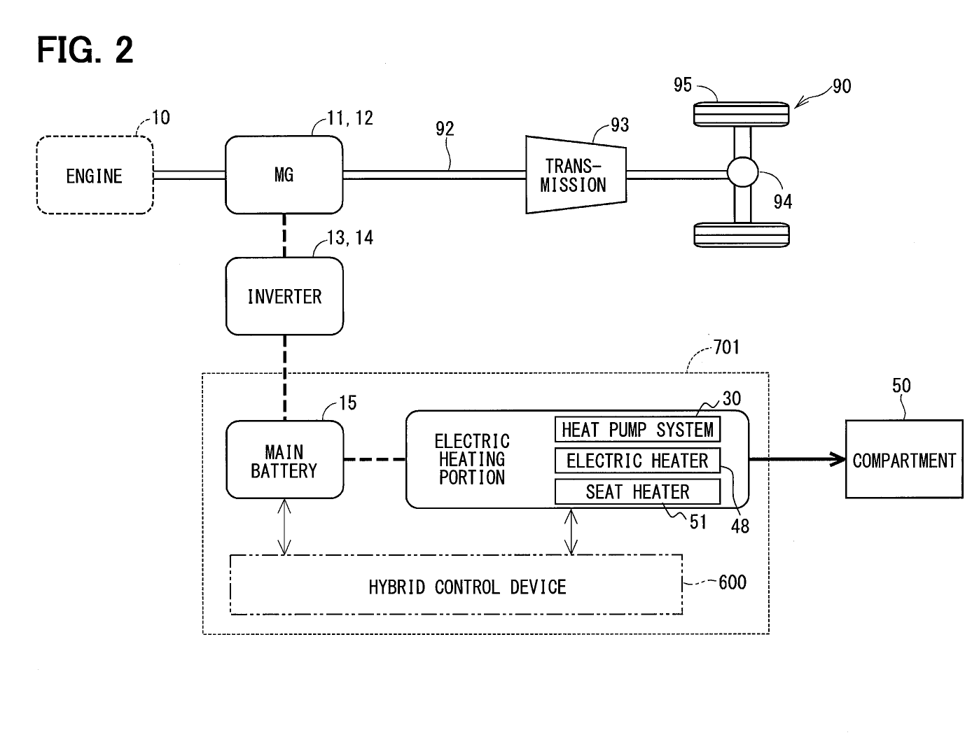

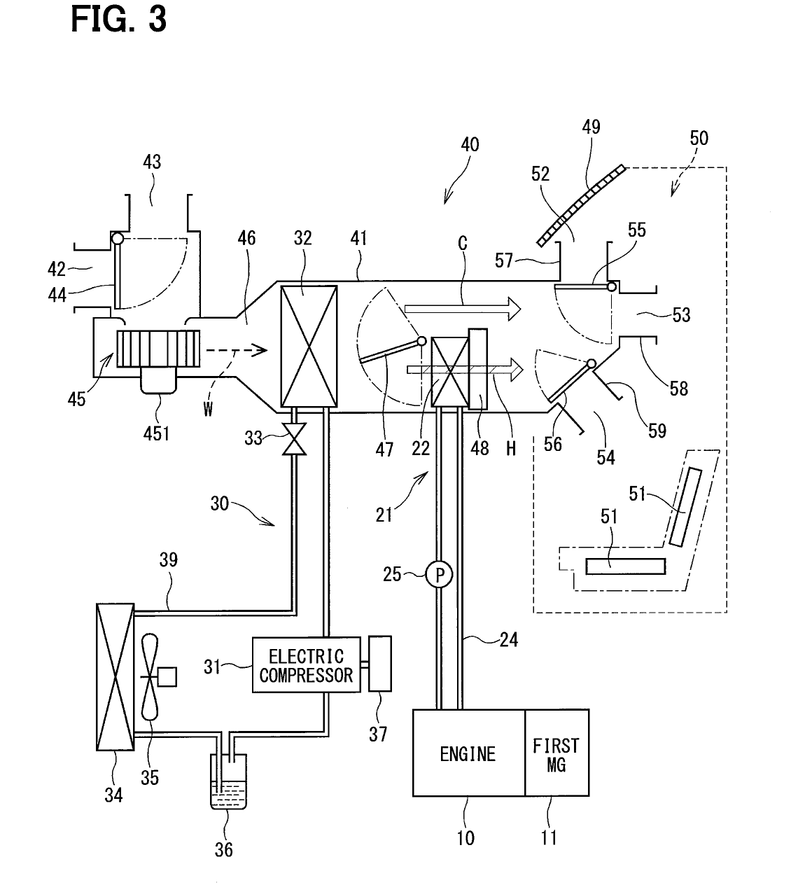

Next, referring to FIGS. 2 and 3, an exhaust heater 21 relative to a heating of a compartment 50, and the heat pump system 30 that is one of electric heating portions, will be described.

The exhaust heater 21 includes a heater core 22, a circulation passage 24, and the water pump 25. The exhaust heater 21 is a system generating heat while uses an exhaust heat of the engine 10. According to the present disclosure, the water pump 25 is electrically driven.

A water jacket is provided in a cylinder block of the engine 10 or a cylinder head of the engine 10. A coolant is circulated through the water jacket to cool down the engine 10. The water jacket communicates with the circulation passage 24 including a coolant pipe. The water pump 25 is provided in the circulation passage 24 to adjust a flow rate of the coolant circulating through the circulation passage 24. The flow rate of the coolant circulating through the circulation passage 24 is adjusted by changing a discharge quantity of the water pump 25.

The circulation passage 24 extends from an outlet of the engine 10 toward the heater core 22, and returns back to the engine 10 via the heater core 22. A temperature sensor 29 which detects a temperature of the coolant is disposed at a position of the circulation passage 24 adjacent to the outlet of the engine 10. According to the present disclosure, the temperature of the coolant corresponds to a coolant temperature.

The heater core 22 heat exchanges from the coolant in the circulation passage 24. As shown in FIG. 3, in an air-conditioner 40, the blower 45 is provided at a position upstream of the heater core 22, and sends air toward the heater core 22. The air sent from the blower 45 flows through the heater core 22, and is heated by a heat exchange with the coolant to become a warm air. The warm air is supplied from an outlet of the blower 45 to the compartment 50. According to the above configuration, a heat quantity supplied from the coolant to the compartment 50 via the heater core 22 is controlled by controlling the discharge quantity of the water pump 25 and a blowing state of the blower 45.

The heat pump system 30 is a heat exchanging system using the electric power to exchange heat of interior and exterior of the compartment 50. The heat pump system 30 includes an electric compressor 31, an interior heat exchanger 32, an expansion valve 33, an exterior heat exchanger 34, an accumulator 36, and a refrigerant circulation passage 39 that includes a refrigerant pipe communicating with the above members. The interior heat exchanger 32 corresponds to an evaporator, and the exterior heat exchanger 34 corresponds to a condenser.

The electric compressor 31 has a compressor motor. The compressor motor rotates according to the electric power supplied from the main battery 15 via a compressor inverter 37, and then the electric compressor 31 compresses a refrigerant. The electric compressor 31 discharges the compressed refrigerant toward the interior heat exchanger 32.

The interior heat exchanger 32 executes a heat exchange between the heated refrigerant discharged by the electric compressor 31 and a blowing air sent from the blower 45 toward the compartment 50. The blowing air flows through the interior heat exchanger 32 and is heated by a heat exchange with the heated refrigerant to become the warm air. The warm air is supplied from the outlet of the blower 45 to the interior of the vehicle 90. In this case, the refrigerant is cooled down by the heat exchange with the blowing air. The refrigerant flowed through the interior heat exchanger 32 is decompressed by the expansion valve 33 and is discharged to the exterior heat exchanger 34.

The exterior heat exchanger 34 is disposed at a position outside of the interior of the vehicle 90. The exterior heat exchanger 34 executes a heat exchange between the refrigerant and an outer air. The radiator fan 35 sends an outer air toward the exterior heat exchanger 34. The refrigerant decompressed by the expansion valve 33 is heated by a heat exchange with the outer air at the exterior heat exchanger 34. The refrigerant heated by the exterior heat exchanger 34 is discharged to the electric compressor 31 via the accumulator 36.

Next, the control device 600 of the vehicle control system 1 will be described.

The control device 600 includes a hybrid control device 60, a battery control device 61, a MG control device 62, an engine control device 63, and an air-conditioner control device 64. The hybrid control device 60 is functioned as a center portion to communicate with other devices. The hybrid control device 60, the battery control device 61, the MG control device 62, the engine control device 63, and the air-conditioner control device 64 are constructed by microcomputers each of which includes a CPU, a ROM, and a RAM, and execute programs stored in the ROMs to execute various controls.

The hybrid control device 60 receives signals from an accelerator sensor 66, a shift switch 67, a brake switch 68, a vehicle-speed sensor 69, and the temperature sensor 29, and controls the vehicle 90 by balancing the driving force of the engine 10, the driving force of the first MG 11, and the driving force of the second MG 12, based on the signals.

The battery control device 61 includes a detection portion which detects the power residual of the main battery 15 and a temperature of the main battery 15, or a measurement portion which measures the power residual of the main battery 15 and the temperature of the main battery 15. According to the present disclosure, the temperature of the main battery 15 corresponds to a battery temperature. Further, the battery control device 61 controls the power residual to be in the predetermined range.

The MG control device 62 controls a driving of the first MG 11 or a driving of the second MG 12 by controlling a switch operation of the inverters 13 or 14, based on a command of the hybrid control device 60.

The engine control device 63 controls an operation of the engine 10 by a fuel injection control, an ignition timing control, a valve timing control, or an intake quantity control, based on a command of the hybrid control device 60.

The air-conditioner control device 64 controls the water pump 25, the electric compressor 31, and the blower 45, based on a command of the hybrid control device 60.

The control device 600 may include a combination or partition of a part of the above devices, or may include other devices other than the above devices. As shown in FIG. 1, dashed arrows indicate a part of signals transmitted from other devices to a corresponding controlled object, for example. As shown in FIG. 1, a dashed arrow directly communicates the hybrid control device 60 with the sub battery 16. However, another device may be provided between the hybrid control device 60 and the sub battery 16.

According to the present disclosure, the control device 600 controls the main battery 15, the sub battery 16, and an electric heating portion, as main controlled objects. In other words, it is necessary that the battery control device 61 and the air-conditioner control device 64 are included in the control device 600. Hereafter, the control device 600 will be used as a main controller.

The above configuration is common according to the present disclosure.

### First Embodiment

Referring to FIGS. 2 to 6, the battery warming-up system 701 according to a first embodiment of the present disclosure will be described. FIG. 2 is a diagram showing the battery warming-up system 701. As shown in FIG. 2, the engine 10 indicated by a dashed line may be canceled in the vehicle 90. In other words, the present embodiment is also applied to an electric vehicle without an engine. According to the present embodiment, the first MG 11, the second MG 12, the inverter 13, and the inverter 14 are provided, as an example. According to the present disclosure, at least one MG driven by the electric power of the main battery 15 may be provided.

As shown in FIG. 2, the battery warming-up system 701 includes the main battery 15, the electric heating portion, and the control device 600. The electric heating portion heats the compartment 50 by using an electric energy, and includes the heat pump system 30, an electric heater 48, and a seat heater 51.

As shown in FIG. 3, the air-conditioner 40 includes a combination of the heat pump system 30, the exhaust heater 21, and the electric heater 48. The air heated by the heat pump system 30, the exhaust heater 21, or the electric heater 48 is sent by the blower 45 to adjust a temperature of the compartment 50. According to the present embodiment, the temperature of the compartment 50 corresponds to a compartment temperature.

The heat pump system 30 and the electric heater 48 correspond to the electric heating portion.

The air-conditioner 40 is provided at a position in a front portion of the compartment 50, and includes a case 41 through which the blowing air flows. The case 41 includes an inlet placed at a first end portion, and plural outlets placed at a second end portion opposite to the first end portion. The blowing air flows through the outlets toward the compartment 50. A blowing passage 46 through which the blowing air flows is provided between the inlet and the outlets.

As shown in FIG. 3, the blower 45 and an air switch 44 are placed at positions upstream of the case 41. The air switch 44 is driven by an actuator such as a Servo motor, and changed an opening degree of an inner air inlet 42 and an opening degree of an outer air inlet 43. The inner air inlet 42 and the outer air inlet 43 correspond to air inlets.

The blower 45 is a centrifugal blower rotatably driven by a blower motor 451. In the case 41, the blower 45 generates an air flow W flowing toward the compartment 50. The blower 45 adjusts a flow rate of a cold air or the warm air which flows from the outlets toward the compartment 50.

The case 41 houses the interior heat exchanger 32 which heats or cools down the blowing air sent by the blower 45, the heater core 22, and the electric heater 48.

The interior heat exchanger 32 is placed at a position downstream of the blower 45. The interior heat exchanger 32 takes a greater part of the blowing passage 46 in a radial direction of the blowing passage 46. In other words, a gap is generated between an inner periphery of the blowing passage 46 and an outer periphery of the interior heat exchanger 32. The heater core 22 is placed at a position downstream of the interior heat exchanger 32. The heater core 22 takes a part of the blowing passage 46 in the radial direction of the blowing passage 46. In other words, the heater core 22 may take a substantially half part of the blowing passage 46 in the radial direction of the blowing passage 46.

The electric heater 48 which heats the air by using a heat source other than the exhaust heat of the engine 10 is placed at a position downstream of the heater core 22. The electric heater 48 is a positive temperature coefficient (PTC) heater, and further heats the warm air flowing through the heater core 22.

According to other embodiments, another interior heat exchanger may be provided at the same position of the electric heater 48.

An air mix damper 47 which adjusts the compartment temperature is placed at a position upstream of the heater core 22. The air mix damper 47 is driven by an actuator such as a Servo motor, and an opening degree of which is adjusted. The air mix damper 47 adjusts a heat quantity supplied from the outlets of the case 41 to the compartment 50 by adjusting a mixing rate of the cold air flowing through a passage C and the warm air flowing through a passage H. The passage H is a passage divided by the air mix damper 47 and housing the heater core 22 and the electric heater 48, and the passage C is the other passage divided by the air mix damper 47.

When the heating is not necessary, the blowing air of the blower 45 is terminated, or the air mix damper 47 opens to a cold-air side. In other words, the opening degree of the air mix damper 47 is adjusted such that the air mix damper 47 opens the passage C and blocks the passage H.

At a most downstream of the case 41, a defroster opening 52, a face opening 53, and a foot opening 54 are provided.

A defroster duct 57 is connected to the defroster opening 52. The defroster duct 57 includes a defroster outlet at a most downstream of the defroster duct 57. The warm air mainly flows from the defroster outlet toward an inner surface of a front-window glass 49 of the vehicle 90.

A face duct 58 is connected to the face opening 53. The face duct 58 includes a face outlet at a most downstream of the face duct 58. The cold air mainly flows from the face outlet toward an upper half of the body of each of the passengers.

A foot duct 59 is connected to the foot opening 54. The foot duct 59 includes a foot outlet at a most downstream of the foot duct 59. The warm air mainly flows from the foot outlet toward foots of each of the passengers.

Two switches 55 and 56 are rotatably provided at positions inside of the defroster opening 52, the face opening 53, and the foot opening 54. The switches 55 and 56 are driven by an actuator such as a Servo motor. The switches 55 and 56 can switch an output mode to a face mode, a high-level mode, a foot mode, a foot defroster mode, or a defroster mode.

Further, a seat heater 51 may be included in at least one of a seating surface and a backrest in a seat provided in the compartment 50 for passengers. The seat heater 51 corresponding to the electric heating portion generates heat by using the electric power of the main battery 15.

When the battery temperature becomes low in the vehicle control system 1, an output of the main battery 15 is insufficient, and a driving force of the vehicle 90 is decreased. According to the present embodiment, the output of the main battery 15 corresponds to a battery output. Since an input and output loss of the main battery 15 increases in accordance with an increase in inner resistance of the main battery 15, it is necessary to provide a regeneration limit to prevent harmful effects due to an excessive charge, and a regeneration power is decreased.

To solve the above matters, Japanese Patent No. 3687270 discloses a technology that an operation time of an engine is decreased to increase an output of a battery, and the battery is warmed by a heat generation of an inner resistance of the battery. However, when the engine cannot be stopped or an operation of the engine cannot be restricted, the above technology cannot be used to solve the above matters.

JP-H07-079503 discloses a first technology that a target charging voltage is increased in a case where an engine operates to warm up a battery by an excessively-generated power, and a second technology that an electric heating catalyst is supplied by an electric power to warm up the battery. However, according to the first technology, when the engine generates the excessively-generated power in a case where a travelling load is high, an engine efficiency is deteriorated. Further, according to the second technology, when the electric heating catalyst cannot be used, the battery cannot be warmed.

According to the present embodiment, since the control device 600 increases the battery output by using the following controls in the vehicle 90 provided with the electric heating portion, the battery warming-up system 701 suitably warms up the main battery 15 without affecting by a condition whether the operation of the engine 10 can be controlled.

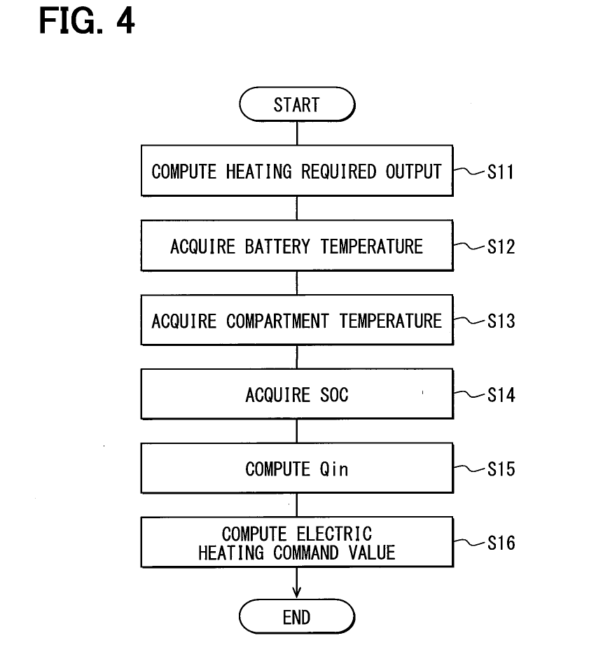

Next, referring to FIGS. 4 to 6, a first battery output-increasing control executed by the control device 600 of the battery warming-up system 701 according to the first embodiment by using an electric heater will be described.

The following routines are executed at a predetermined period in a case where an ignition switch is turned on. Alternatively, the following routines may be executed in a case where the main battery 15 is necessary to be warmed, for example, when the battery temperature is less than or equal to a predetermined temperature.

At S11, the control device 600 computes a required output of the main battery 15 according to heating requests relative to the heat pump system 30, the electric heater 48, and the seat heater 51. The required output corresponding to a heating required output is a base command value.

At S12, the control device 600 acquires the battery temperature. At S13, the control device 600 acquires the compartment temperature. At S14, the control device 600 acquires the battery residual (SOC) of the main battery 15. S12, S13, and S14 may be executed in other orders. Further, one or two of S12, S13, and S14 may be canceled. Furthermore, values of the battery temperature, the compartment temperature, and the SOC of the main battery 15 may be detected by detection portions such as temperature sensors, or may be computed according to formulas or maps based on other physical values.

At S15, the control device 600 computes a heating output-increasing quantity (Qin) based on the battery temperature, the compartment temperature, and the SOC of the main battery 15. Specifically, the control device 600 computes the heating output-increasing quantity by a map previously stored in the control device 600.

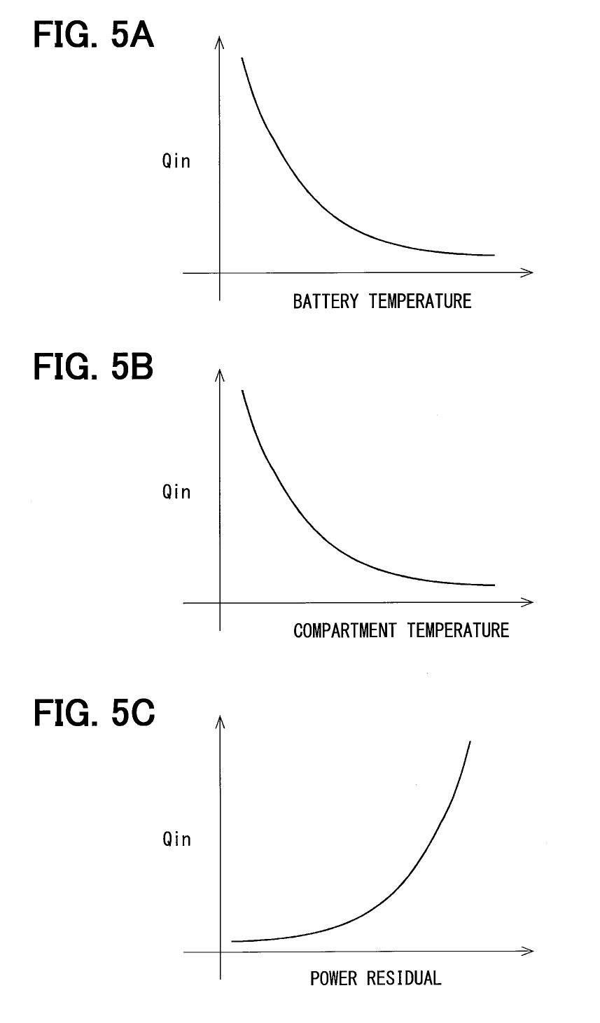

FIG. 5A is a graph showing a relationship between the battery temperature and a heating output-increasing quantity, FIG. 5B is a graph showing a relationship between the compartment temperature and a heating output-increasing quantity, and FIG. 5C is a graph showing a relationship between the power residual and a heating output-increasing quantity. As shown in FIG. 5A, the lower the battery temperature becomes, the greater the heating output-increasing quantity is set to meet a warming-up request of the main battery 15. As shown in FIG. 5B, the lower the compartment temperature becomes, the greater the heating output-increasing quantity is set to meet a comfortability of the passenger. As shown in FIG. 5C, the higher the SOC becomes, the greater the heating output-increasing quantity is set because a dischargeable quantity is large.

In addition, the control device 600 may compute the battery temperature, the compartment temperature, and the SOC according to formulas without using maps.

At S16, the control device 600 computes an electric heating command value by adding the heating output-increasing quantity to the heating required output. The control device 600 controls the heat pump system 30, the electric heater 48, or the seat heater 51 to generate heat to heat the compartment 50, based on the electric heating command value.

As shown in FIG. 3, in the air-conditioner 40, the control device 600 controls a blowing rate of the blower 45 and an opening degree of the air mix damper 47, so as to adjust the heat quantity supplied to the compartment 50. When no heating request is generated, the control device 600 terminates the blower 45 or controls the air mix damper 47 to open to the cold-air side.

Thus, since the electric power of the main battery 15 is supplied to the electric warming-up portion, the main battery 15 can be warmed by the heat generation of the inner resistance.

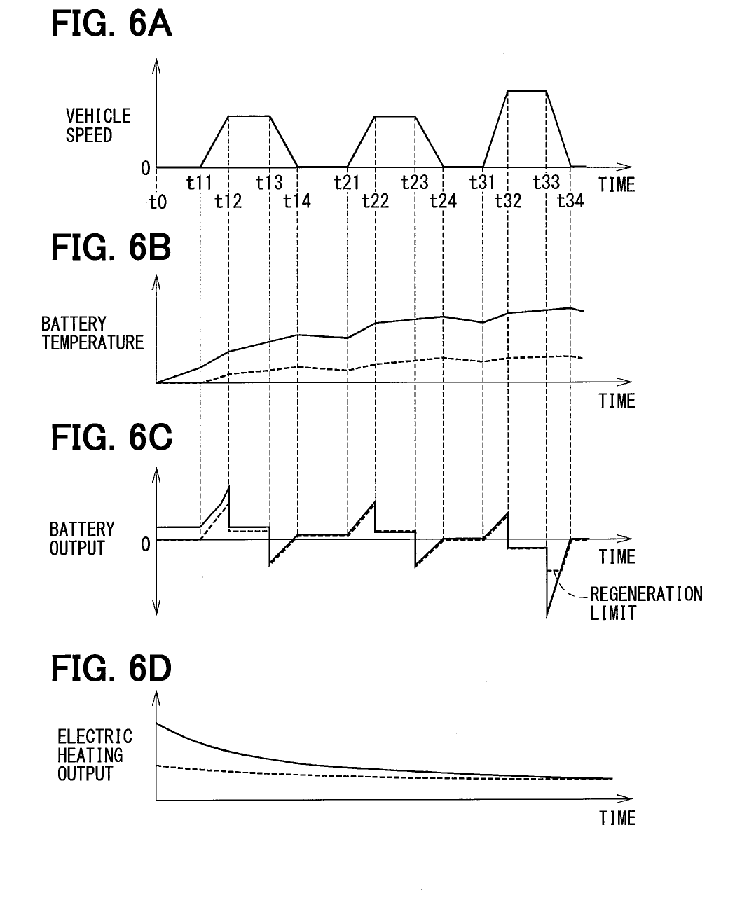

FIGS. 6A, 6B, 6C, and 6D are time charts showing effects of the first battery output-increasing control. FIG. 6A is a time chart showing a relationship between a vehicle speed and time, FIG. 6B is a time chart showing a relationship between the battery temperature and time, FIG. 6C is a time chart showing a relationship between the battery output and time, and FIG. 6D is a time chart showing a relationship between an electric heating output and time. As shown in FIGS. 6A to 6D, solid lines show properties according to the present embodiment that the first battery output-increasing control is executed, and dashed lines show properties according to a comparison example that the first battery output-increasing control is not executed.

As shown in FIG. 6A, the vehicle 90 repeats a cycle including an acceleration operation, a fixed-speed travelling operation, a deceleration operation, and a stop, for three times. In a first cycle, the vehicle 90 operates in the acceleration operation from a time point t11 to a time point t12, operates in the fixed-speed travelling operation from the time point t12 to a time point t13, operates in the deceleration operation from the time point t13 to a time point t14, and stops from the time point t14 to a time point t21 that is a start time point of a second cycle. The second cycle and a third cycle are similar to the first cycle. Further, a fixed speed in the third cycle is greater than a fixed speed in the first and second cycle.

As shown in FIG. 6B, according to the comparison example, the battery temperature starts to increase during a time period from the time point t11 to the time point t12. However, according to the present embodiment, since the electric heating output is increased to generate the battery output (discharge the electric power) as shown in FIGS. 6C and 6D, the warming-up of the main battery 15 is started in an early stage since a time point t0 that the vehicle 90 stops before the time point t11.

As shown in FIG. 6C, the main battery 15 discharges the electric power in the acceleration operation, and charges the electric power by the regeneration operation of the first MG 11 or the second MG 12 in the deceleration operation. The battery output is substantially constant in the fixed-speed travelling operation and in the stop of the vehicle 90.

In the time period from the time point t11 to the time point t12, according to the present embodiment, the electric heating output is increased with respect to the comparison example as shown in FIG. 6D, the battery output is increased with respect to the comparison example as shown in FIG. 6C, an increasing rate of the battery temperature is greater than that of the comparison example as shown in FIG. 6B. Therefore, since the battery output is different between the present embodiment and the comparison example in a time period from the time point t0 to the time point t12, the battery temperature of the present embodiment is totally greater than that of the comparison example over time as shown in FIG. 6B.

In a time period from a time point t33 to a time point t34, according to the comparison example, since the battery temperature is lower than that of the present embodiment as shown in FIG. 6B, the inner resistance of the main battery 15 is higher than that of the present embodiment. Therefore, a regeneration limit for preventing harmful effects due to an excessive charge is executed, and a regeneration electric power is less than that of the present embodiment.

According to the present embodiment, the inner resistance can be decreased by increasing the battery temperature. Therefore, the input loss of the main battery 15 is decreased, and it is unnecessary to provide the regeneration limit. Thus, a decrease of the regeneration power due to the regeneration limit can be avoided.

According to the present embodiment, the output of the main battery 15 is increased by supplying the electric power to the electric heating portion, and the main battery 15 can be suitably warmed. Therefore, since a power loss due to a decrease of the inner resistance of the main battery 15 is improved or the battery output becomes sufficient, the driving power of the vehicle 90 can be properly ensured. Further, the decrease of the regeneration power due to the regeneration limit can be avoided.

### Second Embodiment

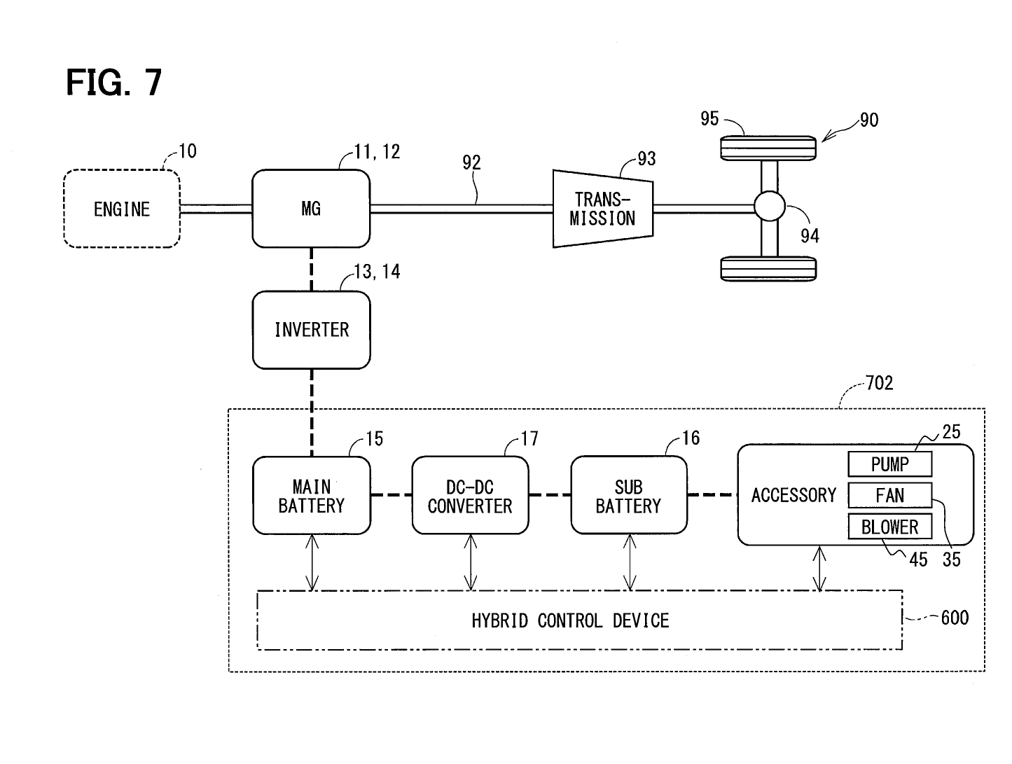

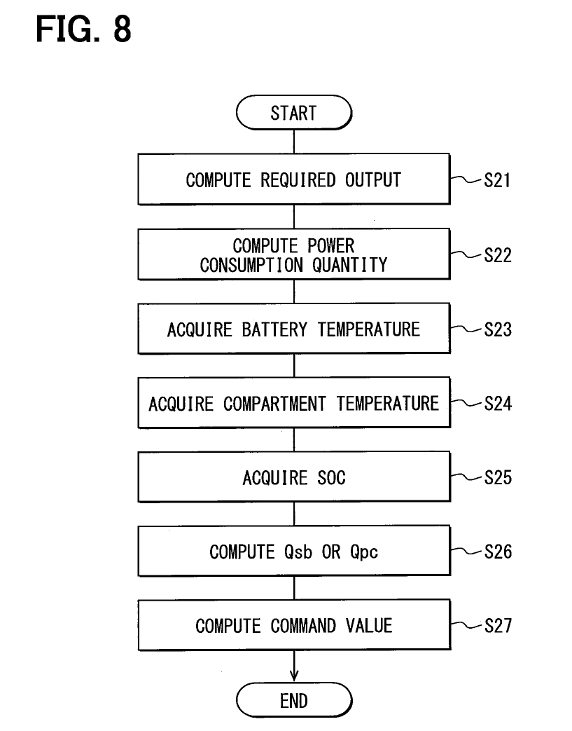

Referring to FIGS. 7 and 8, a battery warming-up system 702 according to a second embodiment of the present disclosure will be described. FIG. 7 and FIG. 8 correspond to FIG. 2 and FIG. 4, respectively. The substantially same parts and the components as the first embodiment are indicated with the same reference numeral and the same description will not be reiterated.

As shown in FIG. 7, the battery warming-up system 702 includes the main battery 15, the DC-DC converter 17, the sub battery 16, the accessories, and the control device 600. The DC-DC converter 17 converts a direct electric power of high voltage from the main battery 15 to a direct electric power of low voltage, and supplies the direct electric power of low voltage to the sub battery 16. In addition, according to other embodiments, the DC-DC converter 17 may be canceled, and the direct electric power may be directly supplied from the main battery 15 to the sub battery 16.

According to the present embodiment, the accessories include the water pump 25, the radiator fan 35, and the blower 45.

Referring to FIG. 8, a second battery output-increasing control executed by the control device 600 according to the second embodiment by using the accessories and the sub battery 16 will be described.

At S21, the control device 600 acquires a power residual of the sub battery 16, and computes a charging request quantity as a required output. At S22, the control device 600 computes a power consumption quantity based on an operation state of the accessories, and measures whether the power residual of the sub battery 16 is lowered according to the power consumption quantity.

S23, S24, and S25 correspond to S12, S13, and S14 shown in FIG. 4, respectively. At S26, the control device 600 computes an increasing quantity Qsb of a sub-battery charging quantity or an increasing quantity Qpc of the power consumption quantity, based on the battery temperature, the compartment temperature, and the power residual of the main battery 15. When a sub-battery chargeable quantity is insufficient, the accessories are operated to use greater electric power to reduce the power residual of the sub battery 16, and a charging quantity from the main battery 15 to the sub battery 16 is ensured. At S27, the control device 600 computes a command value of the sub-battery charging quantity or a command value of the power consumption quantity, by adding the increasing quantity Qsb or Qpc to the required output.

The increasing quantity Qsb or Qpc can be computed by using a map as the same as the map shown in FIGS. 5A, 5B and 5C.

According to the second embodiment, the second battery output-increasing control has the same effects as the first battery output-increasing control in the first embodiment. Further, the first embodiment and the second embodiment can be combined. Specifically, the main battery 15 supplies the electric power to the electric heating portion and the sub battery 16. Therefore, the effects in the first embodiment can be further improved.

### Other Embodiment

(a) The vehicle control system to which the battery warming-up system of the present disclosure is applied is unnecessary to include all the members shown in FIG. 1. The vehicle control system may include the main battery 15, and the control device 600. Further, the vehicle control system may include one of the electric heating portions power supplied by the main battery 15. Alternatively, the vehicle control system may further include the sub battery 16 and one of the accessories.

(b) The electric heating portion is not limited to the heat pump system 30, the electric heater 48, and the seat heater 51. The electric heating portion may be any other devices or members which can generate heat by using the electric energy.

(c) A pump may be used as the accessory other than the water pump 25, such as a fuel pump or an oil pump. A fan may be used as the accessory other than the radiator fan 35, such as a fan used for air cooling. Further, any other devices which use the electric power on the vehicle may be used as accessories.

The present disclosure is not limited to the embodiments mentioned above, and can be applied to various embodiments within the spirit and scope of the present disclosure.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A battery warming-up system comprising:
a main battery mounted to a vehicle to supply an electric power to drive the vehicle, the main battery warmed by a heat generation of an inner resistance of the main battery according to an input and output of the electric power;
an electric heating portion heating a compartment of the vehicle by using the electric power supplied from the main battery; and
a control device controlling a temperature of the main battery by controlling a power supply from the main battery to the electric heating portion.

2. The battery warming-up system according to claim 1, wherein
the control device supplies the electric power that is greater than a heating required output required by the electric heating portion to the electric heating portion.

3. The battery warming-up system according to claim 1, wherein
the control device adjusts the electric power supplied to the electric heating portion, according to the temperature of the main battery.

4. The battery warming-up system according to claim 1, wherein
the control device adjusts the electric power supplied to the electric heating portion, according to a temperature of the compartment.

5. The battery warming-up system according to claim 1, wherein
the control device adjusts the electric power supplied to the electric heating portion, a power residual of the main battery.

6. The battery warming-up system according to claim 1, wherein
the electric heating portion includes one of a heat pump system, an electric heater, and a seat heater.

7. The battery warming-up system according to claim 6, wherein
the electric heating portion is the electric heater or the heat pump system which is provided in a passage divided by an air mix damper in an air-conditioner,
the air-conditioner adjusts a mix rate of a cold air and a warm air sent by a blower by using the air mix damper and supplies a mixed air of the cold air and the warm air to the compartment, and
the control device controls a blowing rate of the blower and an opening degree of the air mix damper, and adjusts a heat quantity supplied to the compartment.

8. The battery warming-up system according to claim 7, wherein
when no heating request is generated, the control device terminates the blower or controls the air mix damper to open to a cold-air side.

9. A battery warming system comprising:
a main battery mounted to a vehicle to supply an electric power to drive the vehicle, the main battery warmed by a heat generation of an inner resistance of the main battery according to an input and output of the electric power;
a sub battery directly connected to the main battery or indirectly connected to the main battery via a DC-DC converter, the sub battery charged by the electric power directly supplied from the main battery or by an electric power converted by the DC-DC converter from a DC power of the main battery;
an accessory operating by using the electric power supplied from the sub battery; and
a control device controlling a temperature of the main battery by controlling a power supply from the main battery to the electric heating portion.

10. The battery warming-up system according to claim 9, wherein
the control device controls the main battery to supply the electric power to the sub battery according to a power residual of the sub battery.

11. The battery warming-up system according to claim 9, wherein
the control device reduces a power residual of the sub battery by increasing a power consumption quantity of the accessory.

12. The battery warming-up system according to claim 9, wherein
the control device adjusts the electric power supplied to the sub battery or the power consumption quantity of the accessory, according to the temperature of the main battery.

13. The battery warming-up system according to claim 9, wherein
the control device adjusts the electric power supplied to the sub battery or the power consumption quantity of the accessory, according to a temperature of the compartment.

14. The battery warming-up system according to claim 9, wherein
the control device adjusts the electric power supplied to the sub battery or the power consumption quantity of the accessory, according to a power residual of the main battery.

15. The battery warming-up system according to claim 9, wherein
the accessory includes one of a pump, a fan, and a blower.
